(19) United States
(12) Patent Application Publication
(10) Pub. No.: US 2006/0228569 A1
(43) Pub. Date: Oct. 12, 2006

(54) Production method of substrate with black film and substrate with black film

(76) Inventors: Tadaaki Kojima, Kanagawa (JP); Hiroyasu Taguchi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/567,567

(22) PCT Filed: Aug. 6, 2004
(86) PCT No.: PCT/JP04/11642

§ 371 Date: Feb. 8, 2006

Related U.S. Application Data
(60) Provisional application No. 60/566,604, filed on Apr. 30, 2004.

(30) Foreign Application Priority Data
Aug. 8, 2003 (JP) 2003-290754

(51) Int. Cl. B32B 15/04; B05D 1/18; C25D 3/12

(52) U.S. Cl. 428/457; 428/698; 427/437; 427/443.1; 205/271

(57) ABSTRACT

A method for producing a substrate with black film is provided, comprising forming a dull plating film on a surface of a substrate, forming an electroless plating film containing a sulfur or nitrogen compound on the surface of the plating film, and forming a black film on the surface of the electroless plating film. This substrate with black film is used for devices which generate heat due to sliding or friction or generate/accumulate heat due to a chemical reaction, such as semiconductor device, vacuum device, rotating device and heat exchanger, and the black film has excellent heat radiating properties with an emissivity of 0.8 or more. Also, this substrate with black film has high corrosion resistance against halogen-type corrosive gases and exhibits excellent release gas properties and corrosion resistance in vacuum devices.

### CROSS REFERENCES OF RELATED APPLICATION

This application is an application filed under 35 U.S.C. §111(a) claiming benefit pursuant to 35 U.S.C. §119(e) of the filing date of Provisional Application 60/566,604 filed on Apr. 30, 2004, pursuant to 35 U.S.C. §111(b).

### TECHNICAL FIELD

The present invention relates to a method for producing a substrate with black film having a black film excellent in the heat radiating properties on a surface of a substrate such as metal, plastic or ceramic, and also relates to a substrate with black film.

More specifically, the present invention relates to a method of forming a black film having an excellent heat radiating property with an emissivity of 0.8 or more on a surface of a substrate used for devices which generate heat due to sliding or friction or generate/accumulate heat due to a chemical reaction, such as semiconductor device, vacuum device, rotating device and heat exchanger, and also relates to a substrate with black film having the black film and exhibiting excellent heat radiating properties.

### BACKGROUND ART

With recent progress of high-performance electronic devices such as semiconductor device and display or high-performance family-use personal computers or home appliances, the heat value of IC or semiconductor device mounted on these devices is increasing and how to deal with the heat is a problem of great importance. Particularly, in the case of precision components, the measures generally taken therefor are, for example, to forcedly discharge the heat by using a fan or provide an air flow path in the device itself and naturally radiate the internal heat by so-called convective heat transfer.

In this way, it is expected to attain stable operation or elongation of component life by enhancing the heat radiating property of a precision device to decrease the internal temperature of the device and protect a component susceptible to heat or by suppressing the elevation of temperature of a heating element itself such as IC.

In general, the heat transfer mechanism includes three mechanisms, that is, “heat conduction”, “convective heat transfer” and “heat radiation”. In the “heat conduction”, the heat is transferring from a high-temperature part to a low-temperature part within a solid. In the “convective heat transfer”, the heat is transferring between a moving fluid and a solid surface. In the “heat radiation”, the heat is transferring by utilizing an electromagnetic wave radiated from a material surface according to the temperature thereof. Accordingly, in considering the heat radiation performance, these three mechanisms must be studied.

For enhancing the heat radiating property by heat conduction, it is generally necessary to shorten the heat conduction route, enlarge the area and use a material having a high heat conductivity. The high heat conducting property is characteristic of metals and, for example, a metal film is formed on a resin surface by electroless plating to elevate the heat conducting property, whereby the heat radiating properties of a component can be enhanced. JP-A-2003-46022 describes a technique of improving the heat radiating property by subjecting a resin material substrate comprising an epoxy resin or a polyimide material to plating with Cu which is a metal having high heat conducting property.

As for the convective heat transfer, it is most effective to increase the amount of air coming into contact and this is generally attained by increasing the area of opening or the number of openings.

As for the heat radiation, several attempts are being made at present to impart a high emissivity to a member and increase the heat release value by heat radiation. The high emissivity is accentuated in a substance having a black surface, and black resin coating and black anodize (anodic oxide film) are being used in practice.

However, in the case of black resin coating, the resin material as the base of the coating material is itself extremely poor in the heat conducting property as compared with metals and the black resin coating is not an excellent technique when considering the efficiency of heat radiating properties of a device.

On the other hand, the black anodize has a problem in that this is formed by anodization of an aluminum substrate and the substrate material is limited to a certain aluminum alloy or in that the coat takes a special form having fine pores and therefore, the emission gas properties are inferior.

As for the metal black coat, several techniques have been reported, such as black nickel plating and black chromium plating. These are all an electrolytic plating treatment and have a problem in that since the step of causing coloration is an electrode reaction, a uniform metal black coat can be formed only on a substrate having a very simple shape, such as plate material.

Furthermore, it is reported that the emissivity of the metal black film is 0.63 when formed by plasma spray coating, 0.50 by black chromium plating, and 0.42 by black Ni plating. Thus, the metal black film is greatly inferior in the emissivity as compared with black resin coating or black anodize. In addition, this film has a large problem in the reflectance (gloss), because the film is a metal coat and therefore, has metallic luster peculiar to metal.

In the meanwhile, the black film is being utilized also in the absorption of energy because of its excellent absorption properties of infrared ray. JP-A-10-319381 discloses a light valve where light is absorbed as a heat energy into a black resin body and the heat is transferred to a heat radiating plate and then released into air. Similarly, JP-A-10-184541 describes an evacuation device employing a system where a black surface-treated member is provided as a radiation heat-absorbing material and the heat is transferred and then released outside a container.

In a vacuum device, the constituent member is constructed by a metal such as stainless steel, aluminum or titanium and particularly, in recent years, for the purpose of reducing the amount of gas released and lowering the ultimate pressure, the surface asperities even in a fine level are sometimes decreased to provide an almost mirror state. If the case is so, the reflectance becomes large and the heat radiation due to infrared ray repeatedly undergoes mirror reflection on the wall surface to impose a great thermal load on other portions.

The heat radiating properties are greatly governed by an emissivity and, for example, in the case of a cage body, when there is no change in the cage temperature and the outer space temperature, as the emissivity of the cage body material is higher, the heat release value proportionally increases. Therefore, the metal black film is demanded to have an emissivity of at least 0.6 or more.

### DISCLOSURE OF INVENTION

An object of the present invention is to provide a substrate having a black film excellent in the heat conducting property and elevated in the surface emissivity to 0.8 or more Another object of the present invention is to provide a product using this substrate with black film and elevated in the heat radiating property, such as semiconductor device, electronic device and vacuum device.

The brief summary of the present invention is as follows.

1. A method for producing a substrate with black film, comprising forming a dull plating film on a surface of a substrate, forming an electroless plating film containing a sulfur or nitrogen compound on the surface of the dull plating film, and forming a black film on the surface of the electroless plating film.

2. The production method as described in 1, wherein the dull plating film is a dull nickel plating film or a dull nickel alloy plating film.

3. The production method as described in 2, wherein the dull nickel plating film or dull nickel alloy plating film is formed by an electrolytic or electroless process.

4. The production method as described in 2 or 3, wherein the nickel alloy for forming the dull nickel alloy plating film is a nickel-phosphorus alloy, a nickel-boron alloy or a nickel-phosphorus-boron alloy.

5. The production method as described in 1, wherein the electroless plating film is an electroless nickel plating film or an electroless nickel alloy plating film.

6. The production method as described in 5, wherein the nickel alloy for forming the electroless nickel alloy plating film is a nickel-phosphorus alloy, a nickel-boron alloy or a nickel-phosphorus-boron alloy.

7. The production method as described in 1, wherein the black film is a black film mainly comprising a nickel oxide.

8. A method for producing a substrate with black film, comprising forming an electroless plating film containing a sulfur or nitrogen compound as an additive on a surface of a substrate having asperities formed on at least a part of the surface thereof, and forming a black film on the surface of the electroless plating film.

9. The production method as described in 8, wherein the asperities on the substrate surface are formed by shot-blasting or etching the surface.

10. The production method as described in 8, wherein the electroless plating film is an electroless nickel plating film or an electroless nickel alloy plating film.

11. The production method as described in 10, wherein the electroless nickel alloy plating film is at least one plating film selected from the group consisting of a nickel-phosphorus alloy film, a nickel-boron alloy film and a nickel-phosphorus-boron alloy film.

12. The production method as described in 8, wherein the black film is a black film mainly comprising a nickel oxide.

13. A method for producing a substrate with black film, comprising forming a dull composite plating film on a surface of a substrate, forming an electroless plating film containing a sulfur or nitrogen compound on the surface of the dull composite plating film, and forming a black film on the surface of the electroless plating film.

14. The production method as described in 13, wherein the dull composite plating film is a dull plating film obtained by co-depositing an electrically non-conducting particle.

15. The production method as described in 14, wherein the dull composite plating film is a dull composite nickel plating film or a dull composite nickel alloy plating film.

16. The production method as described in 15, wherein the dull composite nickel plating film or dull composite nickel alloy plating film is formed by an electrolytic or electroless process.

17. The production method as described in 15 or 16, wherein the alloy for forming the dull composite nickel alloy plating film is a nickel-phosphorus alloy, a nickel-boron alloy or a nickel-phosphorus-boron alloy.

18. A substrate with black film, comprising a substrate having on the surface thereof a dull plating film, an electroless plating film containing a sulfur or nitrogen compound formed on the surface of the dull plating film, and a black film formed on the surface of the electroless plating film.

19. The substrate with black film as described in 18, wherein the dull plating film is a dull nickel plating film or a dull nickel alloy plating film.

20. The substrate with black film as described in 18, wherein the dull nickel plating film or dull nickel alloy plating film is formed by an electrolytic or electroless process.

21. The substrate with black film as described in 19 or 20, wherein the nickel alloy for forming the dull nickel alloy plating film is a nickel-phosphorus alloy, a nickel-boron alloy or a nickel-phosphorus-boron alloy.

22. The substrate with black film as described in 18, wherein the electroless plating film is an electroless nickel plating film or an electroless nickel alloy plating film.

23. The substrate with black film as described in 22, wherein the nickel alloy for forming the electroless nickel alloy plating film is a nickel-phosphorus alloy, a nickel-boron alloy or a nickel-phosphorus-boron alloy.

24. The substrate with black film as described in 18, wherein the black film is a black film mainly comprising a nickel oxide.

25. A substrate with black film, comprising a substrate having asperities formed on at least a part of the surface thereof and having on the surface thereof an electroless plating film containing a sulfur or nitrogen compound as an additive, and a black film formed on the surface of the electroless plating film.

26. The substrate with black film as described in 25, wherein the asperities on the substrate surface are formed by shot-blasting or etching the surface.

27. The substrate with black film as described in 25, wherein the electroless plating film is an electroless nickel plating film or an electroless nickel alloy plating film.

28. The substrate with black film as described in 27, wherein the electroless nickel alloy plating film is at least one plating film selected from the group consisting of a nickel-phosphorus alloy film, a nickel-boron alloy film and a nickel-phosphorus-boron alloy film.

29. The substrate with black film as described in 25, wherein the black film is a black film mainly comprising a nickel oxide.

30. A substrate with black film, comprising a substrate having on the surface thereof a dull composite plating film, an electroless plating film containing a sulfur or nitrogen compound formed on the surface of the dull composite plating film, and a black film formed on the surface of the electroless plating film.

31. The substrate with black film as described in 30, wherein the dull composite plating film is a dull plating film containing an electrically non-conducting particle.

32. The substrate with black film as described in 30, wherein the dull composite plating film is a dull composite nickel plating film or a dull composite nickel alloy plating film.

33. The substrate with black film as described in 32, wherein the dull composite nickel plating film or dull composite nickel alloy plating film is formed by an electrolytic or electroless process.

34. The substrate with black film as described in 32 or 33, wherein the alloy for forming the dull composite nickel alloy plating film is a nickel-phosphorus alloy, a nickel-boron alloy or a nickel-phosphorus-boron alloy.

35. The substrate with black film as described in any one of 18 to 34, which has a fluorinated passive film on the surface of the black film.

36. The substrate with black film as described in any one of 18 to 35, wherein the substrate is aluminum, aluminum alloy, copper, stainless steel, plastic or ceramic.

37. A heat exchanger component having on the surface thereof the substrate with black film described in any one of 18 to 36.

38. An optical device component having on the surface thereof the substrate with black film described in any one of 18 to 36.

39. A rotating device or sliding component having on the surface thereof the substrate with black film described in any one of 18 to 36.

### EFFECT OF THE INVENTION

According to the present invention, a substrate having a black film excellent in the heat radiating properties with an emissivity of 0.8 or more, which is used for a semiconductor device or a vacuum device, is obtained. The device using this substrate with black film has high heat radiating properties and the device life is greatly extended. Also, the efficiency of heat exchanger is enhanced.

The substrate with black film of the present invention has excellent properties in comparison with conventional black films, such as high corrosion resistance against halogen-type corrosive gases and less release of gas.

### BEST MODE FOR CARRYING OUT THE INVENTION

The present invention is described in detail below.

As for the substrate for use in the substrate with black film having excellent heat radiating property of the present invention, for example, metal, plastic or ceramic can be used.

Among these, examples of the metal include aluminum, aluminum alloy, titanium, titanium alloy, iron, stainless steel, copper, copper alloy, magnesium, magnesium alloy, nickel and nickel alloy.

Examples of the plastic include ABS, polyimide, polyacrylate, nylon, polyethylene and polypropylene.

The surface of the substrate is preferably subjected to a cleaning treatment so as to form a metal plating film thereon. For example, a known pretreatment according to the substrate, such as pickling, shot blasting, degreasing with use of a solvent or an alkali solution, removal of oxide film, zinc displacement, nickel strike and copper cyanide strike, is applied to the substrate surface as needed.

By applying the shot blasting or acid-alkali etching to the substrate surface, certain asperities are generated on the substrate surface, so that the surface gloss can be decreased and a plating film having a lower reflectance can be formed.

The surface-treated substrate surface is then subjected to electrolytic or electroless plating to form a dull plating film. The dull plating film is preferably a plating film of, for example, copper, tin, nickel, cobalt or an alloy thereof. When the metal species of plating film is nickel, a nickel-phosphorus alloy film, a nickel-boron alloy film and a nickel-phosphorus-boron alloy film are preferred.

In the case of forming a nickel film by electrolytic plating, a known technique such as “nickel sulfamate bath” using nickel sulfamate as the nickel salt or “watts bath” using nickel chloride and nickel sulfate, can be used. Particularly, when the “watts bath” is used, the asperities on the film can be finely changed by a surfactant added and a gloss, semi-gloss or dull nickel film can be obtained. The asperities on the surface must be prudently controlled because these bring about change in the surface glossiness, difference in the reflectance and finally great effect on the heat radiating property.

Also, a satin-like dull nickel coat can be obtained by suspending an electrically non-conducting fine particle in the nickel plating bath and co-depositing this and nickel. The particle size of the fine particle is suitably from 0.02 to 10 microns. As the particle is larger, a duller nickel coat can be obtained. In particular, a slightly large particle having a particle size of 0.5 to 3 microns is preferred for obtaining a dull surface. However, if the particle is large, the adhesion and co-deposition of particle become non-uniform due to the shape of a material to be plated and an appearance having non-uniform gloss may result. Optimal asperities can be produced on the surface by appropriately selecting the particle size and additives such as dispersant and brightening agent.

As the electrically non-conducting fine particle, for example, an oxide such as Al₂O₃, TiO₂ and ZrO₂, a carbide such as SiC, WC and TiC, or a nitride such as BN, AlN and Si₃N₄ is used. Other than the inorganic particle, a resin particle such as polytetrafluoroethylene may also be used.

On the dull plating film, an electroless plating film is formed. When the metal species of this electroless plating is nickel, the plating is performed by using an electroless nickel plating bath containing a phosphorus or boron compound as the reducing agent in addition to a nickel salt.

Examples of the nickel salt include nickel sulfate, nickel chloride, nickel acetate and nickel carbonate. Examples of the phosphorus compound include sodium hypophosphite and potassium hypophosphite. Examples of the boron compound include dimethylaminoboron, diethylaminoboron and sodium boron hydride.

The ratio of nickel salt to phosphorus compound in the plating bath can be appropriately adjusted according to the composition of nickel film. Also, the concentration of each component may be decided by taking account of the stability of bath or the deposition rate, but usually, the nickel salt concentration is preferably from 5 to 50 g/L, more preferably about 20 g/L.

In the plating bath, an organic acid such as acetic acid, malic acid and citric acid, and a chelating agent such as ethylenediaminetetraacetic acid may be added by taking account of stability and pH buffer action.

For the purpose of, for example, preventing the self-decomposition and deposition of nickel compound in the plating bath, a slight amount of sulfur or nitrogen compound is preferably added.

Specific examples of the sulfur compound include metal thiosulfate, lead sulfide, lead sulfate, thioglycolic acid, thiourea and 2-mercaptobenzoylthiazole. Specific examples of the nitrogen compound include metal nitrate such as lead nitrate and bismuth nitrate, amino acids represented by glycine, and amines such as pyridine, aniline and diethanolamine. Among these, metal salts such as lead sulfide and lead nitrate are preferred.

The addition of a sulfur or nitrogen compound is preferred not only in that the compound added prevents the self-decomposition of nickel compound but also in that the deposited electroless plating film containing such a compound is formed as a film slightly inferior in the resistance to oxidation and this property can be advantageously utilized in the chemical conversion treatment of plating film to form a black film.

The pH of the plating bath is usually adjusted, in view of stability of bath or deposition rate, to a range from weakly acidic to weakly alkaline, that is, approximately from 4 to 9. The temperature of the plating bath is determined by taking account of the stability of bath and the deposition rate, but usually, the temperature is preferably from 50 to 90° C. The thickness of the electroless plating film can be appropriately adjusted by controlling the dipping time in the plating solution.

The thickness of the electroless plating film is from 1 to 20 microns, but in order to maintain the dull surface of substrate and prevent the metallic luster, the thickness is preferably from 1 to 10 microns.

For forming a black film on the surface of the thus-formed electroless plating film, the deposited electroless plating film may be subjected to chemical conversion to blacken the surface of the plating film, or a black plating film such as black chromium plating and black nickel plating may be formed by electroless plating on the surface of the dull electroless plating film.

As for the method of blackening the surface of the plating film formed, a method of oxidizing the plating film by using an oxidizing agent (chemical conversion process) can be employed. Regarding the chemical conversion process, JP-A-57-174442 describes a method of dipping a plating film in an aqueous potassium permanganate solution and thereby oxidizing the plating film. Also, JP-A-61-253383 describes a method of adding a sulfur compound such as saccharin to a nickel plating solution so as to incorporate a sulfur portion into the NiP film and thereby accelerate the oxidization to form a black film. However, in these methods, uniform and complete nickel sulfide cannot be produced but non-uniform black plating results and the adhesion strength of film may decrease.

Furthermore, Japanese Patent No. 2023576 describes a method of adding a nitrogen compound to a nickel electroless plating solution, forming an electroless nickel film, and oxidizing this nickel film by using ferric chloride to similarly obtain a black nickel electroless film. The emissivity of the black film formed in Japanese Patent No. 2023576 is about 0.45 and the plating film can be hardly prevented from having gloss peculiar to metal film.

In the present invention, the above-described method may be employed for the blackening step, but it is preferred to surface-treat the electroless plating film by using an aqueous solution of metal salt having strong oxidative property, such as metal nitrate. Specifically, an aqueous nickel nitrate solution dissolved in dilute nitric acid can be used.

In the present invention, a substrate surface is roughened, a dull plating film is formed thereon, an electroless plating film is further formed on the dull plating film and the surface of the obtained electroless plating film is subjected to chemical conversion to blacken the surface, whereby the reflectance of the black metal nickel film can be greatly decreased as compared with conventionally known black films and a metal film having an emissivity of 0.8 or more can be stably formed even on a complicated shape.

The black plating film obtained by such a method is formed in a liquid phase and in the film as it is, water is adsorbing to the outermost surface of black plating film and a large amount of water is contained in the plating film. These water contents sometimes affect the weather resistance, corrosion resistance and reflection properties of the plating film to worsen the heat radiating properties. Therefore, such water contents are preferably removed.

In this meaning, the black film is preferably subjected to a gas treatment so as to enhance the performance of the black plating film.

The gas treatment of the black film can be performed, for example, as follows. The surface of the black plating film is degreased and dehydrated and then the black film is preferably cleaned by holding it in a vacuum or in an inert gas atmosphere at 100 to 250° C., preferably 180 to 220° C., for a predetermined time. When such a gas treatment is performed, the black film is greatly decreased in the water content and contamination and remarkably improved in the weather resistance, corrosion resistance and emission properties.

In order to more enhance the weather resistance and corrosion resistance of the black plating film mainly comprising nickel, the black plating film may be subsequently subjected to a passivation treatment with a fluorine gas in addition to the heat treatment with an inert gas and when the black plating film is cleaned and at the same time, a fluorinated passive film is formed, the corrosion resistance is enhanced. The passivation treatment of treating the black plating film with a fluorine gas may be performed by a general passivation process, but this is preferably performed by the process described in Japanese Patent No. 3094000.

This process is described below by referring to the case where the black plating film is a black nickel film.

For forming a fluorinated passive film on the black nickel film, a forced oxidization treatment is first applied to the black nickel film. The forced oxidization treatment can be performed by contacting the black nickel film with an oxidative gas such as oxygen, nitrous oxide, nitrogen peroxide or ozone, at a high temperature in a reaction furnace. The oxidative gas can be used as a mixed gas with a neutral gas or inert gas. The oxidization reaction is usually performed at 250 to 500° C. The reaction time is from 6 to 48 hours. By forcedly oxidizing the black nickel film in this way, the surface side of the black nickel film is oxidized and a black nickel layer containing nickel oxide is formed. At this time, carbon, hydrocarbon and the like on the surface of the film are removed by combustion with the oxygen gas and at the same time, the water in the film is mostly discharged from the film, as a result, a high-grade state free from these is provided.

Then, the black nickel film with the surface being oxidized is fluorinated to form a nickel fluoride layer.

More specifically, for example, a substrate having formed thereon a nickel alloy film by electroless nickel plating is fixed in a reaction furnace of passing an oxidative gas under atmospheric pressure, the reaction furnace is heated to a predetermined temperature and after holding this state for a predetermined time, a fluorination gas is filled at a predetermined temperature and reacted for a predetermined time, thereby fluorinating the nickel oxide film.

The fluorination treatment is performed by using a 100% gas such as fluorine, chlorine trifluoride and nitrogen trifluoride, a gas obtained by diluting the above-described gas with an inert gas such as nitrogen, helium and argon, or a plasma gas of fluorine or the like. The fluorination treatment temperature is usually from 200 to 400° C. under atmospheric pressure. The reaction time is usually from 1 to 24 hours.

By this fluorination treatment, oxygen in the nickel oxide film formed on the surface of the nickel alloy film reacts with fluorine and a nickel fluoride layer is formed on a part in the surface side. This nickel fluoride layer is usually forming an NiF₂ layer which is formed by an almost stoichiometric reaction between nickel and fluorine in the surface layer side. The nickel oxide need not be completely fluorinated and also, nickel may be present in the elemental form, but in the portion except for the boundary region with the nickel oxide layer, the oxygen is preferably displaced by fluorine and becomes lower than the detection level.

In the present invention, as described above, the black nickel film expressing black color is not entirely replaced by a nickel fluoride layer but the black nickel film is allowed to remain without causing any change in the color tone by, for example, appropriately adjusting the fluorination treatment conditions such as reaction time and temperature.

As for each film thickness in the thus-obtained substrate-dull plating film-electroless plating film-black film or substrate-dull plating film-electroless plating film-black film-nickel fluoride film, the thickness of the dull plating film is preferably from 5 to 30 microns, the total thickness of the electroless plating film and the black film is preferably from 2 to 10 microns in view of durability, generated stress or the like of coat, and the thickness of the nickel fluoride film is preferably from 0.05 to 0.3 microns as a fluorinated passive film in view of weather resistance and corrosion resistance.

### EXAMPLES

The present invention is described below by referring to Examples, but the present invention is not limited to these Examples.

### Example 1

A stainless steel substrate (SUS316L) was pickled as a surface pretreatment and then reacted for a predetermined time at a cathode current density of 4 A/dm² in a dull electrolytic plating bath (composition: nickel sulfate (300 g/L), nickel chloride (45 g/L), boric acid (45 g/L), stabilizer (optimum), emulsion (optimum), pH: 4.5, temperature: 55° C.) to form a dull nickel film having a thickness of 10 microns on the stainless steel surface.

The substrate having the dull nickel film formed thereon was dipped in an electroless nickel plating bath (nickel sulfate (25 g/L), hypophosphorous acid (20 g/L), complexing agent (optimum), lead sulfide (5 mg/L), pH: 4.5, temperature: 90° C.) and reacted for a predetermined time to form an electroless nickel film to a thickness of 10 microns.

The substrate having the electroless nickel film formed thereon was post-treated by dipping and reacting it in a chemical conversion solution for 30 seconds and then the substrate was thoroughly washed and dried to form a black nickel film. The chemical conversion treatment was performed by using an aqueous ferric chloride solution described in Japanese Patent No. 2023576.

After forming the black nickel film by a wet process in this way, the substrate having the black nickel alloy film formed thereon was fixed in a reaction furnace of atmospheric gas phase flow system and after pretreating it at 200° C. for 2 hours under reduced pressure, the temperature was elevated to 250° C. while introducing a nitrogen gas (99.999%). At this temperature, stabilization of the black nickel alloy film was performed for 12 hours. Thereafter, a 20% F₂ gas (nitrogen dilution) was introduced into the nitrogen gas in the reaction furnace to completely displace the inside of the reaction furnace with F₂ gas and by holding this state as it is for 12 hours, the surface of the black nickel alloy film was fluorinated to form a fluorinated passive film. After a predetermined time, the fluorine gas was displaced with nitrogen gas and this state was kept as it is for 1 hour. Then, the temperature was lowered.

### Example 2

An aluminum substrate (A5083 material) was surface-roughened by an alkali etchant (NaOH: 50 g/L, 50° C., 3 minutes) and then dipped in an electroless nickel plating bath (composition: nickel sulfate (25 g/L), hypophosphorous acid (20 g/L), complexing agent (optimum), pH: 4.5, temperature: 90° C.) and reacted for a predetermined time to form a dull nickel-phosphorus alloy film to a thickness of 10 microns by a general double zincate process.

The substrate having the dull nickel-phosphorus alloy film formed thereon was dipped in an electroless nickel plating bath (nickel sulfate (25 g/L), hypophosphorous acid (20 g/L), complexing agent (optimum), stabilizer (optimum), lead sulfide (5 mg/L), pH: 4.5, temperature: 90° C.) and plated for a predetermined time to form an electroless nickel film to a thickness of 10 microns.

Then, the substrate was subjected to a chemical conversion treatment by dipping and reacting it in a chemical conversion solution for 30 seconds and then the substrate was thoroughly washed and dried to form a black nickel film. The chemical conversion treatment was performed at 40° C. by using 60 g/L of nickel nitrate as the chemical conversion solution.

After forming the black nickel film by a wet process in this way, the substrate having the black nickel alloy film formed thereon was fixed in a reaction furnace of atmospheric gas phase flow system and after pretreating it at 200° C. for 2 hours under reduced pressure, the temperature was elevated to 250° C. while introducing a nitrogen gas (99.999%). At this temperature, stabilization of the black nickel alloy film was performed for 12 hours. Thereafter, the nitrogen gas in the reaction furnace was exchanged and displaced by introducing a 20% F₂ gas (nitrogen dilution) and after complete displacement, this state was kept as it is for 12 hours, whereby the surface of the black nickel alloy film was fluorinated to form a fluorinated passive film. After a predetermined time, the fluorine gas was displaced with nitrogen gas and this state was kept as it is for 1 hour. Then, the temperature was lowered.

### Example 3

A stainless steel substrate (SUS316L) was pickled as a surface pretreatment and then reacted for a predetermined time at a cathode current density of 4 A/dm² in a dull electrolytic plating bath (composition: nickel sulfate (300 g/L), nickel chloride (45 g/L), boric acid (45 g/L), stabilizer (optimum), emulsion (optimum), pH: 4.5, temperature: 55° C.) to form a dull nickel film having a thickness of 10 microns on the stainless steel surface.

The substrate having the dull nickel film formed thereon was dipped in an electroless nickel plating bath (nickel sulfate (25 g/L), hypophosphorous acid (20 g/L), complexing agent (optimum), stabilizer (optimum), lead sulfide (optimum), pH: 4.5, temperature: 90° C.) and plated for a predetermined time to form an electroless nickel film to a thickness of 10 microns.

Thereafter, the substrate was post-treated by dipping and reacting it in a chemical conversion solution for 30 seconds and then the substrate was thoroughly washed and dried to form a black nickel film. The chemical conversion treatment was performed by using an aqueous ferric chloride solution described in Japanese Patent No. 2023576.

After forming the black nickel film by a wet process in this way, the substrate having the black nickel alloy film formed thereon was fixed in a reaction furnace of atmospheric gas phase flow system and dried at 200° C. for 2 hours in air flow.

### Example 4

A stainless steel substrate (SUS316L) was pickled as a surface pretreatment, then dipped in an electroless composite plating bath (nickel sulfate (25 g/L), hypophosphorous acid (20 g/L), complexing agent (optimum), stabilizer (optimum), additive (optimum), SiC particle of 3 microns (10 g/L), pH: 4.5, temperature: 90° C.) and reacted for a predetermined time to form a dull composite nickel-phosphorus alloy film having a thickness of 10 microns on the stainless steel surface.

The substrate having the dull composite nickel-phosphorus alloy film formed thereon was dipped in an electroless nickel plating bath (nickel sulfate (25 g/L), hypophosphorous acid (20 g/L), completing agent (optimum), stabilizer (optimum), lead sulfide-(5 mg/L), pH: 4.5, temperature: 90° C.) and reacted for a predetermined time to form an electroless nickel coat to a thickness of 10 microns. Thereafter, the substrate was post-treated by dipping and reacting it in a chemical conversion solution for 30 seconds and then the substrate was thoroughly washed and dried to form a black nickel film. The chemical conversion treatment was performed at 40° C. by using 60 g/L of nickel nitrate.

After forming the black nickel film by a wet process in this way, the substrate having the black nickel film formed thereon was fixed in a reaction furnace of atmospheric gas phase flow system and dried at 200° C. for 2 hours in air flow.

### Comparative Example 1

A stainless steel substrate (SUS316L) was pickled as a surface pretreatment, then dipped in an electroless nickel plating bath (composition: nickel sulfate (25 g/L), hypophosphorous acid (20 g/L), complexing agent (optimum), stabilizer (optimum), pH: 4.5, temperature: 90° C.) and reacted for a predetermined time to form a nickel-phosphorus alloy film having a thickness of 10 microns on the stainless steel surface.

The substrate having the nickel-phosphorus alloy film formed thereon was dipped in an electroless nickel plating bath for blackening (nickel sulfate (25 g/L), hypophosphorous acid (20 g/L), complexing agent (optimum), stabilizer (optimum), lead sulfide (5 mg/L), pH: 4.5, temperature: 90° C.) and reacted for a predetermined time to form an electroless nickel coat to a thickness of 10 microns. Thereafter, the substrate was post-treated by dipping and reacting it in a chemical conversion solution for 30 seconds and then the substrate was thoroughly washed and dried at 200° C. for 2 hours in air flow to form a black nickel film. The total thickness of the films formed was 20 microns.

### Comparative Example 2

A stainless steel substrate (SUS316L) was subjected to a surface pretreatment such as pickling and then reacted for a predetermined time at a cathode current density of 4 A/dm² in an electrolytic plating bath (composition: nickel sulfate (300 g/L), nickel chloride (45 g/L), boric acid (45 g/L), stabilizer (optimum), pH: 4.5, temperature: 55° C.) to form a gloss nickel film having a thickness of 15 microns on the stainless steel surface.

The substrate having the gloss nickel film formed thereon was dipped in a black electrolytic nickel plating bath (nickel sulfate (70 g/L), ammonium sulfate (40 g/L), zinc sulfate (30 g/L), sodium thiocyanate (20 g/L) pH: 5, temperature: 50° C.), reacted for a predetermined time at a cathode current density of 1 A/dm², thoroughly washed and dried at 200° C. for 2 hours in air flow to form a black nickel coat having a thickness of 5 microns. The total thickness of the films formed was 20 microns.

### Comparative Example 3

A stainless steel substrate (SUS316L) was subjected to a surface pretreatment such as pickling and then reacted for a predetermined time at a cathode current density of 4 A/dm² in an electrolytic plating bath (composition: nickel sulfate (300 g/L), nickel chloride (45 g/L), boric acid (45 g/L), stabilizer (optimum), pH: 4.5, temperature: 55° C.) to form a dull nickel film having a thickness of 15 microns on the stainless steel surface.

The substrate having the dull nickel film formed thereon was dipped in a black electrolytic chromium plating bath (chromium trioxide (250 g/L), barium fluoride (4 g/L), temperature: 30° C.), reacted for a predetermined time at a cathode current density of 30 A/dm², thoroughly washed and dried at 200° C. for 2 hours in air flow to form a black chromium coat having a thickness of 1 to 2 microns. The total thickness of the films formed was 17 microns.

Emissivity

The substrates with black film produced in Examples 1 to 4 and Comparative Examples 1 to 3 were determined on the emissivity by a Fourier transform infrared spectro-photometer (JIR-00, manufactured by JEOL Ltd.). The results are shown in Table 1.

The standard light source used was at 80° C. or 160° C. and the average emissivity at 2,200 to 700 cm⁻¹ was measured.

TABLE 1
Emissivity

| | Average Emissivity (%) |
|---|---|
| Example 1 | 82.3 |
| Example 2 | 80.2 |
| Example 3 | 81.3 |
| Example 4 | 80.6 |
| Comparative Example 1 | 45.7 |
| Comparative Example 2 | 42.1 |
| Comparative Example 3 | 49.8 |

Reference

| Sample | Average Emissivity (%) |
|---|---|
| Aluminum A5083 | 0.03 |
| Stainless steel SUS316L | 0.10 |

It is apparent that in all of Examples 1 to 4 of the present invention, the emissivity shows a high numerical value of 80% or more and the performance is greatly enhanced as compared with the black nickel plating film or black chromium plating film conventionally obtained by a wet process.

Evaluation Test of Heat Radiating Properties

In order to evaluate the heat radiating properties, each sample was determined on the heat radiating properties by using an evaluation testing apparatus shown in FIG. 1. The substrate with black film was placed on a heating plate by laying the black film to face upward. The lower part of this heating plate was heated to 100° C. by electric heating and the surface temperature of black film was measured by an infrared radiation thermometer. The substrates of Examples 1 to 4 and Comparative Examples 1 to 3 each was measured on the temperature of black film. The results are shown in Table 2.

TABLE 2
Heat Radiation Properties

| | Infrared Radiation Thermometer |
|---|---|
| | Indication (surface temperature of |
| | black film) (° C.) |
| Example 1 | 74 |
| Example 2 | 66 |
| Example 3 | 73 |
| Example 4 | 71 |
| Comparative Example 1 | 61 |
| Comparative Example 2 | 60 |
| Comparative Example 3 | 62 |

Reference

| | Infrared Radiation Thermometer |
|---|---|
| Sample | Indication (° C.) |
| Aluminum A5083 | 53 |
| Stainless steel SUS316L | 58 |

In Examples 1 to 4 having high emissivity, the amount of infrared ray radiated shows a large numerical value, revealing excellent heat radiating properties.

Release Gas Properties

The substrates with black film each was measured on the release gas properties. The results are shown in Table 3. In the case of using the substrate with black film for vacuum devices, a substrate with black film where the amount of gas released is as small as possible is demanded.

The substrates of Examples 1 to 3 and Comparative Examples 1 to 3 each was heated in a vacuum and at this time, the gas generated from the coat provided on the substrate was measured and analyzed by mass spectrometry (quadrupole mass spectrometer M-QA200TS, manufactured by Anelva Corp.). The heating temperature was elevated from room temperature to 400° C. and the gas released during this heating was analyzed.

TABLE 3
Release Gas Properties

| Component | Example 1 | Example 2 | Example 3 |
|---|---|---|---|
| H₂ | 0.56 | 0.76 | 0.54 |
| H₂O | 64.82 | 75.13 | 100.94 |
| HF | 22.13 | 56.62 | 78.64 |
| CO₂ | 24.50 | 55.22 | 177.85 |
| PF₂ | 3.31 | 10.21 | 8.97 |
| Others | 147.52 | 92.84 | 111.01 |
| Total | 262.84 | 290.78 | 477.95 |
| | Comparative | Comparative | Comparative |
| Component | Example 1 | Example 2 | Example 3 |
| H₂ | 0.51 | 0.15 | 43.27 |
| H₂O | 227.77 | 212.16 | 206.69 |
| HF | 0 | 0 | 12.06 |
| CO₂ | 44.0 | 139.20 | 123.0 |
| PF₂ | 8.47 | 0 | 1.47 |
| Others | 269.94 | 164.96 | 178.25 |
| Total | 550.69 | 534.81 | 565.74 |
| | | | (unit: mass ppm) |

The total detection amount (mass ppm) showed an excellent value in Examples 1 and 2 where a fluorination passivation treatment was performed. Particularly, contaminants originated in carbon were remarkably decreased and in addition, a small numerical value was shown also for the water content. In Comparative Examples 1 to 3, a water content as large as several times was detected. Furthermore, in Comparative Example 3, it was revealed that a large amount of hydrogen was present in the inside.

Corrosion Resistance Properties

The substrates with black film were examined on the corrosion resistance. The results are shown in Table 4. The black film is demanded to function as a corrosion-resistant coat without causing discoloration during its use.

In the evaluation test of corrosion resistance, the black film was exposed at room temperature (25° C.) for 24 hours in a container enclosing an aqueous 35% hydrogen chloride solution as the corrosive aqueous solution and at this time, the reduction in the weight of black film was measured and evaluated. Also, a specimen where a commercially available electroless nickel plating was formed to a thickness of 20 microns was used as a material for comparison and evaluated.

TABLE 4
Corrosion Resistance

| | Percentage Reduction of Weight (%) |
|---|---|
| Example 1 | 0.68 |
| Example 2 | 0.69 |
| Example 3 | 1.43 |
| Comparative Example 1 | 1.45 |
| Comparative Example 2 | 23.1 |
| Comparative Example 3 | 12.8 |

Reference

| Sample | Percentage Reduction of Weight (%) |
|---|---|
| Nickel-phosphorus electroless | 0.70 |
| plating, 20 microns | |

As apparent from Table 4, the black films of Examples 1 to 3 were a coat greatly improved in the corrosion resistance as compared with the commercially available conventional black films of Comparative Examples 2 and 3. Furthermore, in Examples 1 and 2 where the fluorination treatment was performed, the decrease of weight was halved by virtue of the formation of fluorinated passive film. This reveals that the black film has more excellent corrosion resistance.

### BRIEF DESCRIPTION OF DRAWINGS

FIG. 1 is an apparatus for measuring the heat radiating properties of a substrate with black film (specimen).

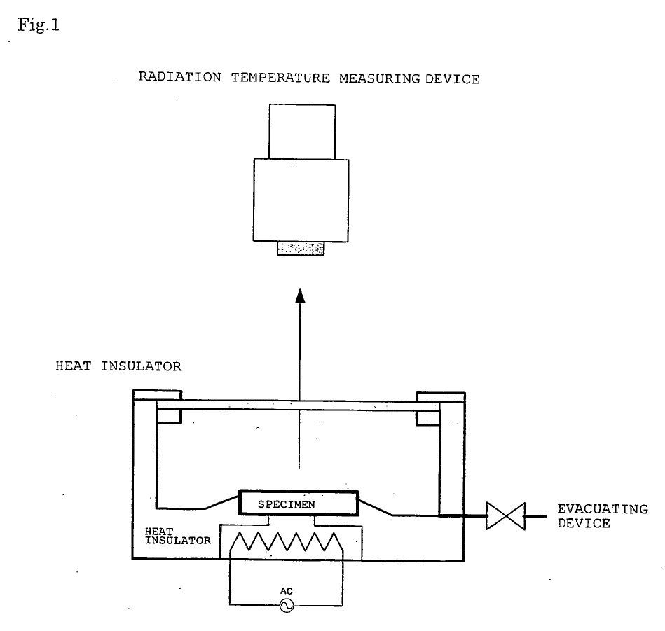

1. A method for producing a substrate with black film, comprising forming a dull plating film on a surface of a substrate, forming an electroless plating film containing a sulfur or nitrogen compound on the surface of said dull plating film, and forming a black film on the surface of said electroless plating film.

2. The production method as claimed in claim 1, wherein the dull plating film is a dull nickel plating film or a dull nickel alloy plating film.

3. The production method as claimed in claim 2, wherein the dull nickel plating film or dull nickel alloy plating film is formed by an electrolytic or electroless process.

4. The production method as claimed in claim 2, wherein the nickel alloy for forming the dull nickel alloy plating film is a nickel-phosphorus alloy, a nickel-boron alloy or a nickel-phosphorus-boron alloy.

5. The production method as claimed in claim 1, wherein the electroless plating film is an electroless nickel plating film or an electroless nickel alloy plating film.

6. The production method as claimed in claim 5, wherein the nickel alloy for forming the electroless nickel alloy plating film is a nickel-phosphorus alloy, a nickel-boron alloy or a nickel-phosphorus-boron alloy.

7. The production method as claimed in claim 1, wherein the black film is a black film mainly comprising a nickel oxide.

8. A method for producing a substrate with black film, comprising forming an electroless plating film containing a sulfur or nitrogen compound as an additive on a surface of a substrate having asperities formed on at least a part of the surface thereof, and forming a black film on the surface of said electroless plating film.

9. The production method as claimed in claim 8, wherein the asperities on the substrate surface are formed by shot-blasting or etching the surface.

10. The production method as claimed in claim 8, wherein the electroless plating film is an electroless nickel plating film or an electroless nickel alloy plating film.

11. The production method as claimed in claim 10, wherein the electroless nickel alloy plating film is at least one plating film selected from the group consisting of a nickel-phosphorus alloy film, a nickel-boron alloy film and a nickel-phosphorus-boron alloy film.

12. The production method as claimed in claim 8, wherein the black film is a black film mainly comprising a nickel oxide.

13. A method for producing a substrate with black film, comprising forming a dull composite plating film on a surface of a substrate, forming an electroless plating film containing a sulfur or nitrogen compound on the surface of said dull composite plating film, and forming a black film on the surface of said electroless plating film.

14. The production method as claimed in claim 13, wherein the dull composite plating film is a dull plating film obtained by co-depositing an electrically non-conducting particle.

15. The production method as claimed in claim 14, wherein the dull composite plating film is a dull composite nickel plating film or a dull composite nickel alloy plating film.

16. The production method as claimed in claim 15, wherein the dull composite nickel plating film or dull composite nickel alloy plating film is formed by an electrolytic or electroless process.

17. The production method as claimed in claim 15, wherein the alloy for forming the dull composite nickel alloy plating film is a nickel-phosphorus alloy, a nickel-boron alloy or a nickel-phosphorus-boron alloy.

18. A substrate with black film, comprising a substrate having on the surface thereof a dull plating film, an electroless plating film containing a sulfur or nitrogen compound formed on the surface of said dull plating film, and a black film formed on the surface of said electroless plating film.

19. The substrate with black film as claimed in claim 18, wherein the dull plating film is a dull nickel plating film or a dull nickel alloy plating film.

20. The substrate with black film as claimed in claim 18, wherein the dull nickel plating film or dull nickel alloy plating film is formed by an electrolytic or electroless process.

21. The substrate with black film as claimed in claim 19, wherein the nickel alloy for forming the dull nickel alloy plating film is a nickel-phosphorus alloy, a nickel-boron alloy or a nickel-phosphorus-boron alloy.

22. The substrate with black film as claimed in claim 18, wherein the electroless plating film is an electroless nickel plating film or an electroless nickel alloy plating film.

23. The substrate with black film as claimed in claim 22, wherein the nickel alloy for forming the electroless nickel alloy plating film is a nickel-phosphorus alloy, a nickel-boron alloy or a nickel-phosphorus-boron alloy.

24. The substrate with black film as claimed in claim 18, wherein the black film is a black film mainly comprising a nickel oxide.

25. A substrate with black film, comprising a substrate having asperities formed on at least a part of the surface thereof and having on the surface thereof an electroless plating film containing a sulfur or nitrogen compound as an additive, and a black film formed on the surface of said electroless plating film.

26. The substrate with black film as claimed in claim 25, wherein the asperities on the substrate surface are formed by shot-blasting or etching the surface.

27. The substrate with black film as claimed in claim 25, wherein the electroless plating film is an electroless nickel plating film or an electroless nickel alloy plating film.

28. The substrate with black film as claimed in claim 27, wherein the electroless nickel alloy plating film is at least one plating film selected from the group consisting of a nickel-phosphorus alloy film, a nickel-boron alloy film and a nickel-phosphorus-boron alloy film.

29. The substrate with black film as claimed in claim 25, wherein the black film is a black film mainly comprising a nickel oxide.

30. A substrate with black film, comprising a substrate having on the surface thereof a dull composite plating film, an electroless plating film containing a sulfur or nitrogen compound formed on the surface of said dull composite plating film, and a black film formed on the surface of said electroless plating film.

31. The substrate with black film as claimed in claim 30, wherein the dull composite plating film is a dull plating film containing an electrically non-conducting particle.

32. The substrate with black film as claimed in claim 30, wherein the dull composite plating film is a dull composite nickel plating film or a dull composite nickel alloy plating film.

33. The substrate with black film as claimed in claim 32, wherein the dull composite nickel plating film or dull composite nickel alloy plating film is formed by an electrolytic or electroless process.

34. The substrate with black film as claimed in claim 32, wherein the alloy for forming the dull composite nickel alloy plating film is a nickel-phosphorus alloy, a nickel-boron alloy or a nickel-phosphorus-boron alloy.

35. The substrate with black film as claimed in claim 18, which has a fluorinated passive film on the surface of the black film.

36. The substrate with black film as claimed in claim 18, wherein the substrate is aluminum, aluminum alloy, copper, stainless steel, plastic or ceramic.

37. A heat exchanger component having on the surface thereof the substrate with black film claimed in claim 18.

38. An optical device component having on the surface thereof the substrate with black film claimed in claim 18.

39. A rotating device or sliding component having on the surface thereof the substrate with black film claimed in claim 18.
